(19) United States
(12) Patent Application Publication
(10) Pub. No.: US 2025/0342630 A1
(43) Pub. Date: Nov. 6, 2025

(54) AI GRAPHIC DESIGN TEXT EDITING ASSISTANT

(71) Applicant: Microsoft Technology Licensing, LLC, Redmond, WA (US)

(72) Inventors: Rolly SETH, Kirkland, WA (US); Madhav Vijay DESHPANDE, Bothell, WA (US); Guillermo Ramos LEAL, Sammamish, WA (US); Andrew MORONEY, Seattle, WA (US)

(73) Assignee: Microsoft Technology Licensing, LLC, Redmond, WA (US)

(21) Appl. No.: 18/655,981

(22) Filed: May 6, 2024

(51) Int. Cl. G06T 11/60; G06F 40/166; G06F 40/263; G06F 40/58

(52) U.S. Cl. CPC G06T 11/60; G06F 40/166; G06F 40/263; G06F 40/58; G06T 2200/24

(57) ABSTRACT

A data processing system implements receiving a user marking of a textual area in a graphic design image; constructing a prompt including the image, the marking, and instructions to a generative model to identify character(s) in the area, to determine design context attribute(s) of the character(s) with respect to the image, and to create a new image based on one changed design context attribute, the attribute(s) including a character design and semantics of the character(s), and a position of the area in the image; providing the prompt to the model and receive the character(s), the attribute(s), and the new image; providing the character(s), the attribute(s), and the new image to a client device; and causing the client device to display at least one of the new image or an editable text box over the area in the image, the box showing the character(s) based on the attribute(s).

### BACKGROUND

Artificial intelligence (AI) has the potential to automate our lives to save time and increase productivity. One area of interest is AI-based design content creation. While some solutions have been developed that make use of AI in design content creation, the existing solutions have many shortcomings. For example, existing generative vision models do not provide support for manual editing of mis-spelled words or unintended texts in an AI-generated graphic design image, such as an invitation card, an event poster, a book cover, or the like. While a user can utilize external image tools to edit such texts, these external image editing tools or applications (e.g., Snapseed®) take extra time and effort to upload and then process the AI-generated image. Moreover, some tools have a steep learning curve (e.g., Photoshop®). Hence, there is a need for a convenient AI-based graphic design text editing function or extension within an AI-based design content creation platform or application that supports manually editing texts in AI-generated images.

### SUMMARY

An example data processing system according to the disclosure includes a processor and a machine-readable medium storing executable instructions. The instructions when executed cause the processor alone or in combination with other processors to perform operations including receiving, via a user interface of a client device, an indication of a user marking of a textual area in a graphic design image, the textual area showing one or more characters; constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image; providing as an input the first prompt to the generative model and receiving as an output the one or more characters and the one or more design context attributes from the generative model; providing the one or more characters and the one or more design context attributes to the client device; and causing the user interface of the client device to display at least one of the new graphic design image or an editable text box over the textual area in the graphic design image, wherein the editable text box shows the one or more characters based on the one or more design context attributes.

An example method implemented in a data processing system includes receiving, via a user interface of a client device, an indication of a user marking of a textual area in a graphic design image, the textual area showing one or more characters; constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image; providing as an input the first prompt to the generative model and receiving as an output the one or more characters, the one or more design context attributes, and the new graphic design image from the generative model; providing the one or more characters, the one or more design context attributes, and the new graphic design image to the client device; and causing the user interface of the client device to display at least one of the new graphic design image or an editable text box over the textual area in the graphic design image, wherein the editable text box shows the one or more characters based on the one or more design context attributes.

An example non-transitory computer readable medium data processing system according to the disclosure on which are stored instructions that, when executed, cause a programmable device to perform functions of receiving, via a user interface of a client device, an indication of a user marking of a textual area in a graphic design image, the textual area showing one or more characters; constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image; providing as an input the first prompt to the generative model and receiving as an output the one or more characters, the one or more design context attributes, and the new graphic design image from the generative model; providing the one or more characters, the one or more design context attributes, and the new graphic design image to the client device; and causing the user interface of the client device to display at least one of the new graphic design image or an editable text box over the textual area in the graphic design image, wherein the editable text box shows the one or more characters based on the one or more design context attributes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example computing environment in which the techniques for an AI graphic design text editing assistant are implemented.

FIG. 1B depicts example AI-generated graphic design images that require text editing.

FIG. 1C depicts an example user interface of an AI-generated graphic design text editing process.

FIG. 2 is a conceptual diagram of an AI graphic design text editing workflow of the system of FIG. 1A according to principles described herein.

FIGS. 3A-3C are diagrams of example user interfaces of an AI graphic design text editing assistant that implements the techniques described herein.

FIG. 4 is a flow chart of an example process for an AI graphic design text editing assistant according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for an AI graphic design text editing assistant are described herein. These techniques provide a technical solution to the technical problem of lack of fast and easy AI graphic design text editing systems and methods that use generative AI to edit text in a graphic design image. The existing AI-based design content creation systems automate many design tasks that were previously done manually, such as design content creation prompt generation, content item template generation, and the like. However, these systems simply do not support manual editing of mis-spelled words or unintended texts in an AI-generated image. In addition, these systems do not understand the context of the text or the design, and thus do not allow for transformation of text content.

To address these technical problems, the proposed technical solution improves design content text editing using an AI graphic design text editing assistant (e.g., using a large multimodal model, LMM) that detects a textual area in a graphic design image marked/highlighted by a user, identifies characters in the textual area, the content of the characters, and design context attributes of the characters (e.g., a character design, a position of the textual area in the graphic design image, or the like), and renders the characters based on the design context attributes. The AI graphic design text editing assistant then displays an editable text box over the textual area in the graphic design image, and the editable text box shows the rendered characters for editing. In addition, the AI graphic design text editing assistant senses the background style behind the textual area as an eraser ink, and applies the eraser ink to in-paint any background space under new text entered by the user in the editable text box. Here, the new text automatically matches the size, font, color, style/angle of the previous text in the graphic design image. Moreover, the AI graphic design text editing assistant automatically detects the language of the identified characters, and downloads the relevant font of the language to render the previous text or the new text in the editable text box over the textual area in the language and font in the graphic design image.

In addition to making the graphic design text editable, the AI graphic design text editing assistant can recommend new text, new character design, new background, or the like based on the context of the text or the graphic design in the graphic design image (e.g., the design context attributes). For example, the AI graphic design text editing assistant automatically changes the characters on an office party invitation card into a more professional looking font after detecting the work nature of the text. The AI graphic design text editing assistant can apply a generative AI model, such as GPT-4V or Dall-E, to generate the recommended graphic design text/design for a user to preview. Such AI-based contextual (i.e., context-aware) transformation recommendation provides an improved method for design content creations.

The system developed by the inventors provides a novel AI graphic design text editing assistant that eliminates the need for using an external application/platform to manually edit text in an AI-generated graphic design image. The AI graphic design text editing assistant autonomously executes the processes of identifying characters and design context attributes behind the scenes, thereby providing an editable text box in the graphic design image. This editable text box not only simplifies user editing text, but also presents AI-generated/recommended new text designs that enhance the graphic design image based on the identified design context attributes. After the graphic design image is finalized, the user can share/publish the finalized graphic design image via any systems, platforms, or applications (e.g., Copilot®, Designer®, Teams®, Google Workspace®, and the like).

In one implementation, the AI graphic design text editing assistant provides a user experience for selectively editing text generated in a design by a large vision model (LVM) such as Dalle-E, where the user picks up a graphical user interface (GUI) element implemented as an “AI eraser” to hover over and highlight a section of text in the design. Via understanding of the context of the text or design, the AI graphic design text editing assistant allows seamless transformation of text content into a recommended design to present to the user. The user is enabled to select among contextualization/personalization change options (e.g., fonts, new text, different languages, etc.). An aspect includes a user experience (UX) related to a feature that allows for text editing of images. For example, following the user highlighting of a text of interest, the AI graphic design text editing assistant hides the text, understands and segments the text content, and then provides further editing options to the user, such as changing the text to all-caps for a title, or suggesting a size, font color, and style appropriate for the design.

A technical benefit of the approach provided herein is providing an AI graphic design text editing service that supports the user's marking of any graphic design text in an image (e.g., intentionally or randomly created in visual artifacts) at runtime, real time understanding of the text being embedded and making the text editable in a text box based on whichever text the user highlights, such as deleting/editing the selected text, thereby increasing the controllability of AI-based graphic design image creation by users.

Another technical benefit of the approach provided herein is to apply AI to determine design context attributes of graphic design text with respect to its graphic design image, and to provide contextual and/or personal suggestions for users to transform/enhance the graphic design text, such as fonts, layout, or the like. Not only does this approach improve the appearance of the graphic design image, but it also reflects user preferences.

Another technical benefit of this approach is storing the initial/transformed graphic design images in the system thereby saving the user significant time and effort in creating and sharing similar graphic design images in the future. These and other technical benefits of the techniques disclosed herein will be evident from the discussion of the example implementations that follow.

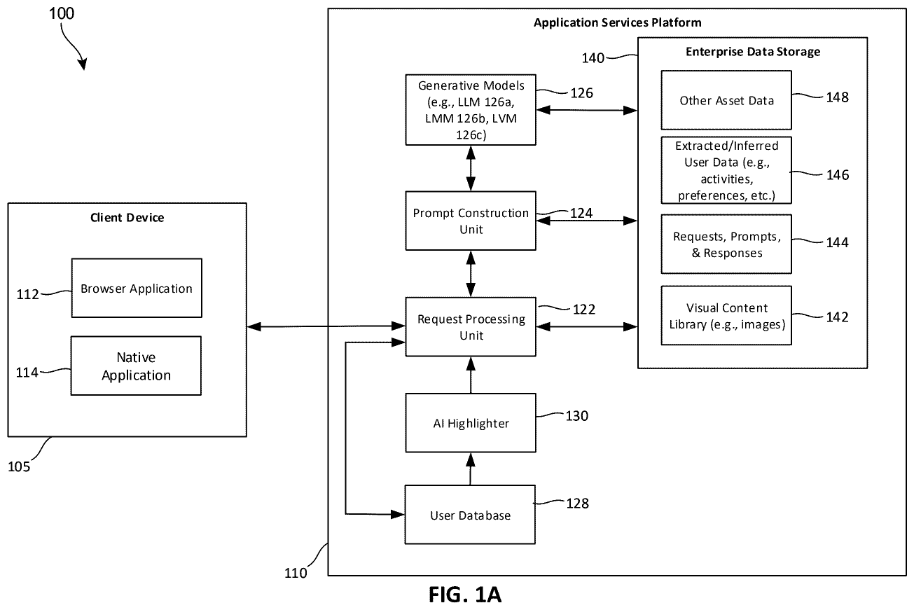

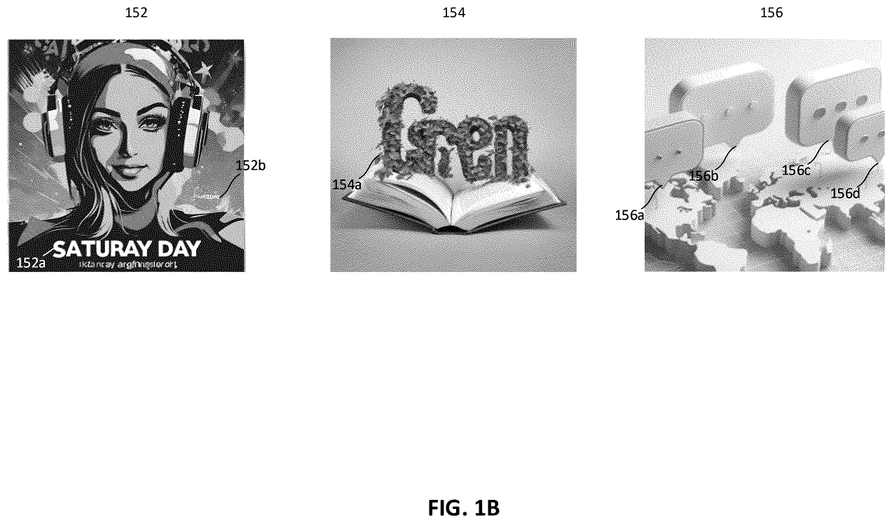

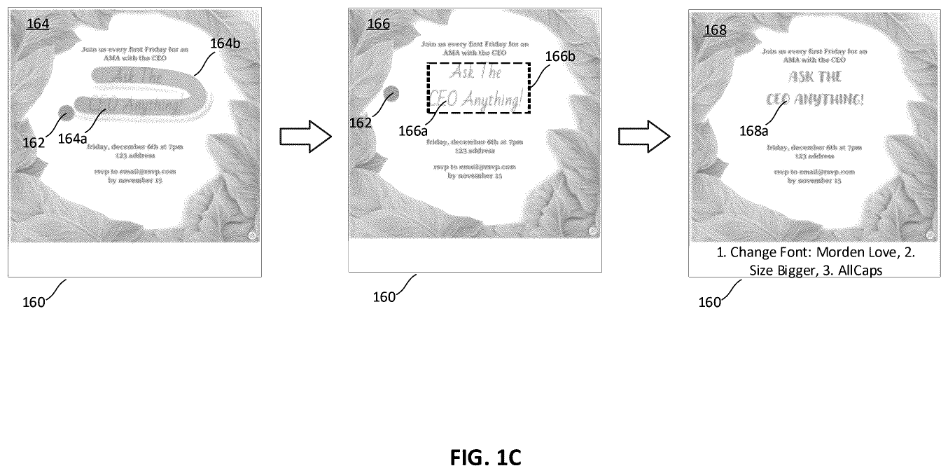

FIG. 1A is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to an AI graphic design text editing assistant, presentation applications, website authoring applications, collaboration platforms, communications platforms, and/or other types of applications in which users may create, view, and/or edit various types of AI graphic design text. In the implementation shown in FIG. 1A, the application services platform 110 also applies generative AI to easily transform/edit graphic design content text according to the techniques described herein. The client device 105 and the application services platform 110 communicate with each other over a network (not shown). The network may be a combination of one or more public and/or private networks and may be implemented at least in part by the Internet.

The client device 105 can be a sender device as well as a user device of a user that subscribes to an AI graphic design text editing assistant provided via the application services platform 110. The service prompts a user of the client device 105 to register the user's content design preferences during service registration. In addition, the service can automatically update the user's content design preferences based on user feedback on the final graphic design images.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1A includes a single client device 105, other implementations may include a different number of client devices that utilize services provided by the application services platform 110.

Graphic design text transformation or editing can change graphic design text content and/or change graphic design text attributes of the identified characters while maintaining the general design/theme of an initial graphic design image. A visual content “theme” is a unifying concept or idea that guides the visual elements of a design project. It helps to convey a specific message or atmosphere and create a cohesive and consistent look and feel for the project. Common elements of a visual content theme include color palette, typography, imagery (e.g., photographs, illustrations, or icons), layout, style (e.g., minimalist, retro, or modern), and the like. A visual content “layout” is the arrangement of predetermined graphic elements such as image, text and style on a page. The visual content layout establishes the overall appearance and relationships between the graphic elements to achieve a smooth flow of message and eye movement for maximum effectiveness or impact. For example, a grid layout can be used to create a sense of order and balance, while a free-form layout can be used to create a sense of creativity or energy.

FIG. 1B shows example AI-generated graphic design images that require text editing. For example, an AI-generated graphic design image 152 (i.e., a DJ party event poster) includes a textual area 152a with a misspelled “Saturay” and some AI-made up words, and another text area 152b with the mis-spelled word “Saturdday.” As another example, an AI-generated graphic design image 154 (i.e., a book cover) includes a textual area 154a with a stylish yet misspelled “Gren.” As yet another example, an AI-generated graphic design image 156 (i.e., a graphic) includes four text-place-holding areas 156a-156d with a series of dots.

FIG. 1C shows an example user interface of an AI-generated graphic design text change process. A user interface (UI) 160 on the left shows an AI-generated graphic design image 164 (i.e., an asking CEO anything event poster) with text of an event title “Ask The CEO Anything!”, and event descriptions of the location, time, and RSVP, or the like. The UI 160 on the left also shows a brush marking 164b created by a user moving/dragging a marker 162 over a textual area 164a of the event title “Ask The CEO Anything!” The AI graphic design text editing assistant automatically identifies the characters in the textual area 164a, and generates an editable text box 166b showing the identified characters 166a of “Ask The CEO Anything!” in an image 166 shown in the UI 160 in the middle of FIG. 1C.

The AI graphic design text editing assistant also automatically determines semantics of the characters in the textual area 164a, and reasons that the poster is about an office event. Before the user edits the identified characters in the editable text box 166b, the AI graphic design text editing assistant automatically recommends/changes the font of the identified characters from the font with thin light brown lines in the image 166 into a font having thicker lines and multi-color in an image 168 in the UI 160 on the left of FIG. 1C. The identified characters 168a blend better in the graphic design image 168 than the identified characters 166a in the graphic design image 166. The user can decide whether to accept the font recommendation. In other words, the AI graphic design text editing assistant can automatically recommend/change the identified characters based on the identified design context attributes, such as the design of the characters themselves, character content, visual hierarchy of the characters in the graphic design image (e.g., heading, subheading, body, footnote, or the like), balance of the characters with respect to white space in the graphic design image, theme, formality, styles, color scheme of the graphic design image, and the like.

The term “graphic design image” refers to any human comprehensible digital graphic design image. Common forms of digital graphic design image include photos, diagrams, charts, images, infographics, videos, animations, screenshots, memes, slide decks, pictograms, ideograms, gaming interfaces, software application backgrounds, publication, email marketing templates, PowerPoint presentations, menus, social media advertisements, banners and graphics, marketing and advertising, packaging, visual identity, art and illustration graphic design, and the like.

Although various embodiments are described with respect to AI-generated graphic design images, it is contemplated that the approach described herein may be used with other digital graphic design images, such an old high school yearbook page image, a scanned magazine cover image, and the like.

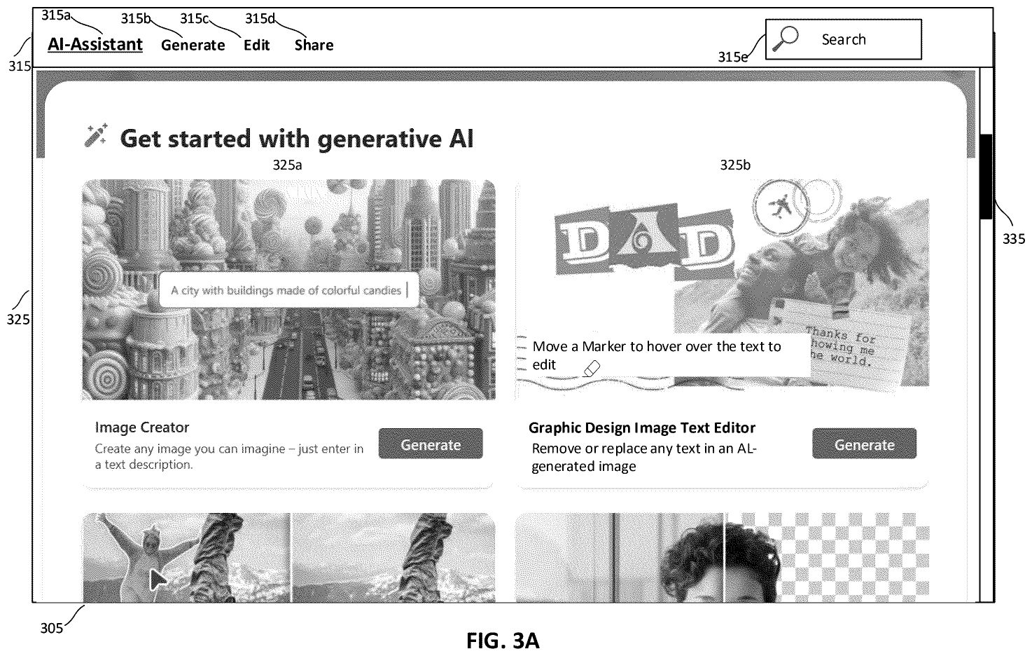

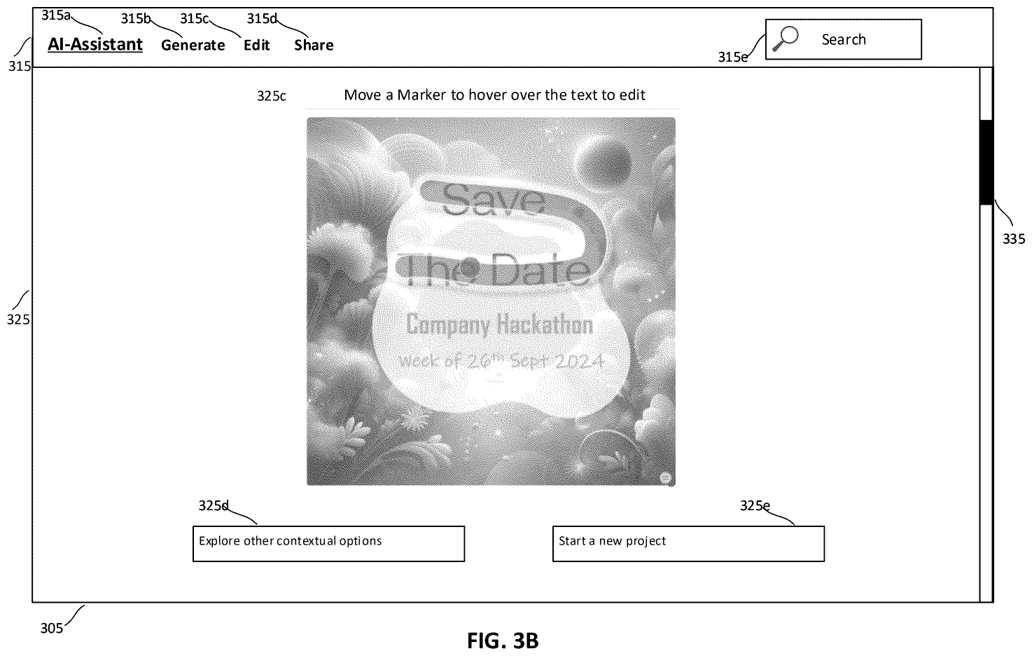

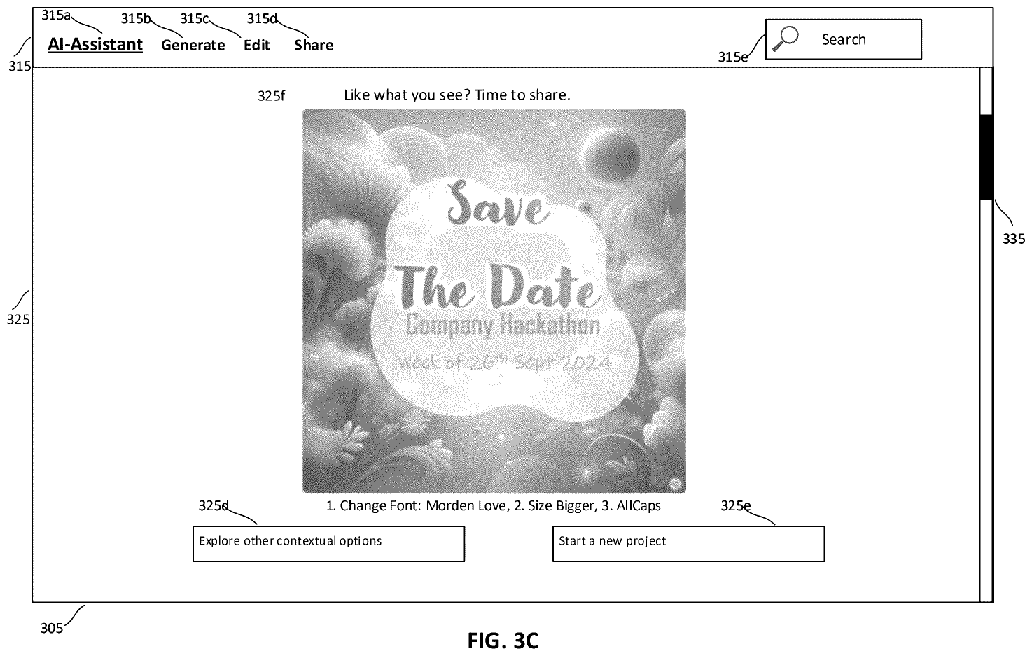

The client device 105 includes a native application 114 and a browser application 112. The native application 114 is a web-enabled native application, in some implementations, that provides the AI graphic design text editing assistant. The web-enabled native application utilizes services provided by the application services platform 110 including but not limited to creating, viewing, and/or editing various AI graphic design text. The native application 114 implements user interfaces shown in FIGS. 3A-3C in some implementations. In other implementations, the browser application 112 is used for accessing and viewing web-based content provided by the application services platform 110. In such implementations, the application services platform 110 utilizes one or more web applications, such as the browser application 112, that enables users to view, create, and/or edit AI graphic design text using, for example, an online application. The browser application 112 implements the user interfaces shown in FIGS. 3A-3C in some implementations. The application services platform 110 supports both the native application 114 and the browser application 112 in some implementations, and the users may choose which approach best suits their needs.

The application services platform 110 includes a request processing unit 122, a prompt construction unit 124, generative model(s) 126, a user database 128, an AI highlighter 130, an enterprise data storage 140, and moderation services (not shown).

The request processing unit 122 is configured to receive requests from the native application 114 and/or the browser application 112 of the client device 105. The requests may include but are not limited to editing AI graphic design text according to the techniques provided herein.

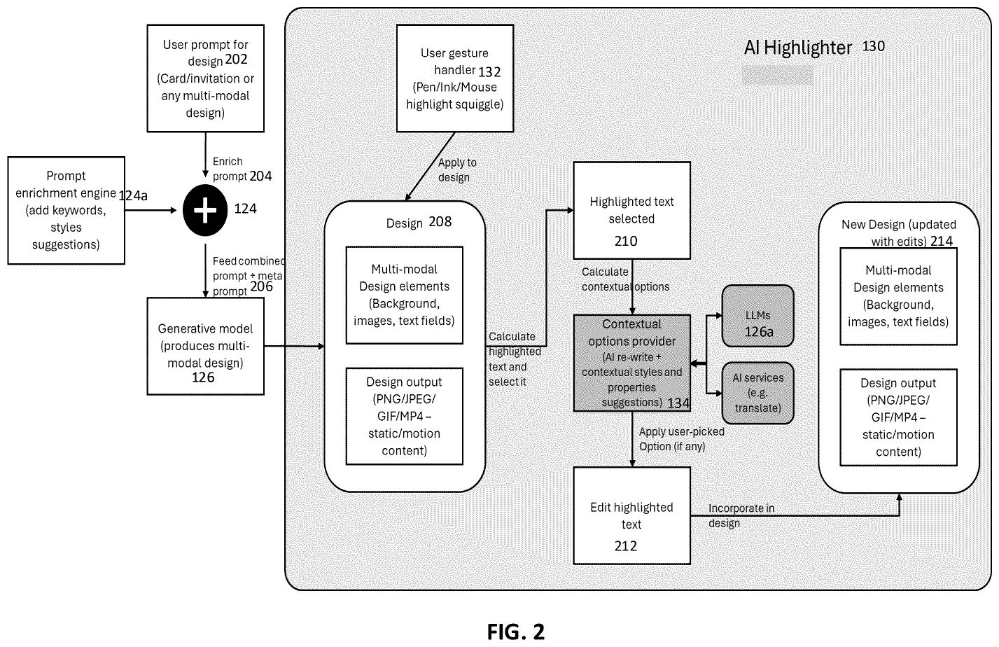

FIG. 2 is a conceptual diagram of an AI graphic design text editing workflow of the system of FIG. 1 according to principles described herein. The workflow leverages the advanced capabilities of LMMs and LVMs. The workflow starts with receiving a user prompt/request 202 (e.g., “create an image or invitation design for ‘ask the CEO anything’ held on Fridays at 7 PM, and use pastel colors.”) for a graphic design image (e.g., a card/invitation or any multi-modal design). The workflow then applies a prompt enrichment engine 124a to enrich/refine the user prompt/request 202.

As another example, the prompt enrichment engine 124a can add keywords, styles, and suggestions into a user prompt 202: [Sprouts in a shape of text “Vine” coming out of an open book] into an enriched prompt 204: [Images of a fairytale book cover featuring sprouts in the shape of the text “Vine” curling out of an open book. The book has a worn leather cover in a deep emerald green, adorned with swirling silver vines and a large amethyst gemstone set in the center. The open pages reveal fantastical script and delicate illustrations in shades of lavender, gold, and sapphire.] The prompt enrichment engine 124a either stands alone or is incorporated in the prompt construction unit 124.

The prompt construction unit 124 then appends the enriched prompt 204 to a meta prompt 206 to call a generative model 126 (e.g., LMM 126b or Dell-E) to generate an initial graphic design image 208 (e.g., the graphic design image 164 of the Ask-CEO-Anything event poster image in FIG. 1C, or a multimodal graphic design). Besides visuals, a multimodal graphic design includes text, audio (e.g., sounds, music, or narration), motion (e.g., animation or video elements), interaction (e.g., user inputs through touch, voice, or gestures), etc. Alternatively, the initial graphic design image 208 can be a non-AI-generated image, such as a scanned magazine cover image.

The workflow deploys the AI highlighter 130 to provide the editing functions via two components: a user gesture handler 132 and a contextual options provider 134. In one embodiment, the user gesture handler 132 works in conjunction with the request processing unit 122 to receive data of user gesture/manipulation of a marking curser (e.g., the marker 162 in FIG. 1C) that marks/highlights a squiggle on the initial graphic design image 208. The marking curser can be controlled by, for example, an alphanumeric input component (for example, a keyboard or a touch screen), a pointing component (for example, a mouse device, a touchpad, or another pointing instrument), and/or a tactile input component (for example, a physical button or a touch screen that provides location and/or force of touches or touch gestures) configured for receiving various user inputs.

The user gesture handler 132 applies the LMM 126b (e.g., GPT-4V standing for Large Multimodal Model, version 4) to continuously scan image(s) and recognizes what text is being shown on the screen, to calculate a textual area marked by the marker 162, and to identify characters in the textual area based on AI optical character recognition (OCR). GPT-4V can scan images and perform OCR tasks to analyze the content of an image and extract text from it.

Besides reading text off an image, GPT-4V also interprets complex graphs, and identify objects. The user gesture handler 132 also applies GPT-4V (e.g., via the same call or another call) to determine design context attributes of the characters 210 with respect to the graphic design image, such as a font and meaning(s) of the characters 210, and a position of the textual area in the graphic design image.

Based on the design context attributes of the characters 210, the contextual options provider 134 works in conjunction with the prompt construction unit 124 to call the LMM 126b (e.g., GPT-4V) and apply a meta prompt to calculate design contextual options for the user. For example, GPT-4V can suggest actions based on the design context attributes of the characters 210 with respect to the graphic design image, such as changing to a professional character font (e.g., due to the work event context), a bigger font size, all caps (e.g., due to the heading context), rewriting “Ask the CEO Anything” into “Ask the CTO Anything” (due to semantic context) switching to bilingual (e.g., due to two area office joint event context), or the like.

In one embodiment, the prompt construction unit 124 calls GPT-4V based on the following meta prompt (see Table 1) added to the user prompt/request 202. This meta prompt combines the functions of the user gesture handler 132 and the contextual options provider 134. As well as other instructions.

TABLE 1

| | |
|---|---|
| a. | understand context of image/design, |
| b. | if text is highlighted, send to GPT the context and content and |
| | ask for recommendation on the following—b.1—what font style |
| | (type, color, shadow, emboss) will go here, b.2 how to make |
| | text more readable/pop-out suggestions (by understanding what |
| | background it is placed), b.3 understand text hierarchy with |
| | respect to entire upload image/design & make other suggestions |
| | of font size, layout, All Caps, |
| c. | if just image arca is highlighted, understand what kind of text |
| | could be ingested there say angled text, text on a path, |
| d. | if mix of text & image portion is selected, understand what pair |
| | of image changes and text changes could go with overall |
| | design & suggest those. |

The contextual options provider 134 works in conjunction with the request processing unit 122 to recommend the design contextual options to the user (e.g., 1. Change Font: Morden Love, 2. Size Bigger, 3. All Caps in FIG. 1C) via a mini app or an AI chat user interface, or another application user interface. Optionally, the AI highlighter 130 retrieves user design preference information from the user database 128, for the LMM 126b to calculate the design contextual options.

Upon a user selection of one of the options, the contextual options provider 134 works in conjunction with the prompt construction unit 124 to call a generative model (e.g., LMM 126b, Dalle-E, a stable diffusion model, or the like) to implement the selected option accordingly. For example, the selected option is implemented by creating an AI image (e.g., the graphic design image 208), inpainting for the text area, and inserting text (e.g., edited text 212) from the LMM 126b (e.g., GPT-4V) to create the final design (e.g., a new image 214 with the edited text 212 such as the graphic design image 168 of the Ask-CEO-Anything event poster image with a new font in FIG. 1C, or a new multimodal graphic design).

In some implementations, the AI highlighter 130 works in conjunction with another generative model 126 (e.g., LMM 126b, Dall-E, Sora, etc.) to transform the initial graphic design image 208 into the new image 214 with other modal content, such as animation, video, etc.

Although various embodiments are described with respect to only text area(s) being highlighted, it is contemplated that the approach described herein may be used with other scenarios when the image area(s) is highlighted. For instance, when only one image area is highlighted by a user, the system will analyze the image area, understand its design context attributes (e.g., objects, theme, color palette, typography, imagery (e.g., photographs, illustrations, or icons), layout, style (e.g., minimalist, retro, or modern), and the like), and suggest what kind of text to ingest therein, such as angled text, text on a path, and the like. As another instance, when a mix of text and image areas are highlighted by a user, the system will analyze both areas, understand respective design context attributes, and suggest what pair of image changes and text changes go with the overall design.

In some implementations, the client device 105 can deploy small generative models, well-suited for situations where computational resources are limited. Example small generative models include Variational Autoencoders (VAEs) with Low-Dimensional Latents, PixelRNN and its Variants, Generative Adversarial Networks (GANs) with Reduced Complexity, Grammar-based models, Markov Chain Models, and the like. Also, generative models are making their way onto mobile devices, such as MobileDiffusion, and Generative Adversarial Networks (GANs) for mobile devices:

Finally, the system incorporates a result check through the LMM 126b to ensure that the final generated graphic design images contain the key features from the initial graphic design image and match the selected design contextual option. Outputs that pass the quality check are then delivered to the client device 105. The system provides users with the ability to edit text in AI-generated graphic design images, thereby increasing the controllability of graphic design image creation by users.

In some implementations, each generative model call needs to pass a responsible AI test. In one embodiment, a responsible AI test is a comprehensive evaluation process that ensures a generative model adheres to ethical principles and operates safely and fairly in the real world. In another embodiment, the test not only checks if the generative model performs its intended task accurately, but also assess its potential for harm and mitigating negative impacts. For instance, the above-referenced meta prompts can be a self-improving agent that can modify its own instructions based on its reflections on user interactions. In one embodiment, the meta prompt can include instructions that guides the agent on how to improve its own instructions based on user positive, neutral, or negative feedback on the outputs, such as a user selection of a thumbs-up tab, a thumbs-down tab, a neutral tab, or a generating-more-image tab, a textual input, or the like. The system can then create another graphic design image based on the refined textual prompt and serve the refined output to the user.

In yet another embodiment, the system further improves the quality of the outputs via a quality check to ensure that the edited graphic design images contains the text as edited and theme of the initial graphic design image. The system can then send the edited graphic design images to the user.

In one embodiment, the prompt construction unit 124 can work in conjunction with the user gesture handler 132 to collect user design content preferences data (e.g., based on user feedback on the new graphic design image 214) and store in the user database 128. The user data can include a username, a user organization, a user preferred graphic design style (e.g., minimalism, retro, art deco, Memphis design, Swiss style, Bauhaus, pop art, punk, etc.), and the like. The user data source(s) can be online/offline databases (e.g., emails, social media posts, and the like), documents, articles, books, presentation content, and/or other types of graphic design content.

FIGS. 3A-3C are diagrams of an example user interface of an AI graphic design text editing assistant that implements the techniques described herein. The example user interfaces shown in FIGS. 3A-3C is a user interface of an AI graphic design text editing assistant within an AI-based design platform, such as but not limited to Microsoft Copilot®. However, the techniques herein for AI graphic design text editing are not limited to use in an AI-based design platform and may be used to edit AI-generated graphic design images for other types of applications including but not limited to presentation applications, website authoring applications, collaboration platforms, communications platforms, and/or other types of applications in which users create, view, and/or edit various AI-generated graphic design images. Such applications can be a stand-alone applications, a plug-in or an Edit button of any application on the client device 105, such as the browser application 112, the native application 114, and the like. For example, the system can work on the web or within a virtual meeting and collaboration application (e.g., Microsoft Teams®) or an email application (e.g., Outlook®). The system can be integrated into the Microsoft Viva® platform or could work within a browser (e.g., Windows® Edge®). The system can also work within a social media website/application (e.g., Facebook®, Instagram®).

FIG. 3A shows an example of a user interface 305 of an AI graphic design text editing assistant in which the user is interacting with AI generative model(s) to edit text in AI-generated graphic design images. The user interface 305 includes a control pane 315, a chat pane 325 and a scrollbar 335. The user interface 305 may be implemented by the native application 114 and/or the browser application 112.

In some implementations, the control pane 315 includes an Assistant button 315a, a Generate button 315b, an Edit button 315c, a Share button 315d, and a search field 315e. The AI-Assistant button 315a can be selected to provide graphic design text editing functions as discussed. In some implementations, the chat pane 325 provides a workspace in which the user can enter prompts in the AI graphic design text editing assistant for editing text in graphic design images. In the example shown in FIG. 3A, the chat pane 325 shows at least two mini application tiles 325a and 325b.

The mini application tile 325a represents an image creator and depicts a description of “Create any image you can imagine-just enter in a text description.” The mini application tile 325a also depicts a prompt enter box over a background image and a “Generate’ button. The prompt enter box shows a sample prompt of “A city with buildings made of colorful candies.”

The mini application tile 325b represents a graphic design image text editor and depicts a description of “Remove or replace any text in an AL-generated image.” The mini application tile 325b also depicts a prompt enter box over a background image and a “Generate’ button. The prompt enter box shows an instruction of “Move a Marker to hover over the text to edit.”

In one embodiment, the image creator invites a user to generate a graphic design image of a company hackathon poster. In another embodiment, the user can select the Generate button 315b to generate the graphic design image. If the user does not like the text in the graphic design image, the user can start the graphic design image text editor in FIG. 3B to edit the text. FIG. 3B shows an instruction 325c of “Move a Marker to hover over the text to edit” above the graphic design image, after the graphic design image text editor is started.

The user can activate the AI-Assistant button 315a to have the AI graphic design text editing assistant remove text from the graphic design image or edit the text in the graphic design image. Alternatively, the user simply moves a marker over the textual area of “Save the Day” in the graphic design image, to activate the AI graphic design text editing assistant directly show suggested contextual text variation for the highlighted text without showing editable text box. The AI graphic design text editing assistant processes the graphic design image and interacts with the user to generate a new graphic design image with edited text (with a more vivid title font to match with the hackathon spirit) in FIG. 3C. FIG. 3C shows an instruction 325f of “Like what you see? Time to share.” above the new graphic design image.

The Share button 315c can be selected to trigger a dropdown list of applications to share the new graphic design image (e.g., the company hackathon poster with a more vivid title font). For example, the user can post the company hackathon poster on a workspace application (e.g., Google Workspace®) to promote the company hackathon. The search field 315d is for a user to enter a search word, phrase, paragraph, and the like within the visual content library 142, the requests, prompts, and responses 144, the extracted/inferred user data 146 (e.g., activities, preferences, or the like), the other asset data 148, and the like. The fields in the AI graphic design text editing assistant can provide auto-fill and/or spell-check functions.

The chat pane 325 further shows a field 325d with an instruction of “Explore other contextual options” and a field 325e with an instruction of “Start a new project.” As such, the user can experiment with other contextual options and/or other graphic design image. For example, the user may want to enlarge the characters, rewrite “Save the Day” into “Sign up Now,” switch to another style, or the like.

Upon a user rejection of a new graphic design image, the system can directly invite user feedback on how to adjust the text in the new graphic design image, such as font being too small, resolution too high/low, colors too bright/dark, background similarity too high/low, and the like. In absence of such specific user feedback details, the system can automatically generate a plurality of text variations for user selection.

In some implementations, the system provides a feedback loop by augmenting thumbs up and thumbs down buttons for each new graphic design image in the user interface 305. If the user dislikes a new graphic design image, the system can ask why and use the user feedback data to improve the generative model(s) 126. A thumbs down click could also prompt the user to indicate whether the text in the new graphic design image was too bright, too dark, too big, too small, or the like.

The LMM 126b can be GPT-4V, Imagen, Contrastive Language-Image Pretraining (CLIP), Flamingo, Perceiver, Multitask Unified Model (MUM), or the like utilized based on considerations of open source, photorealistic, creative control, computational requirements, ease of use, licensing, and the like. The generative model(s) 126 may be included as part of the application services platform 110 or they may be external models that are called by the application services platform 110. In implementations where other models in addition to the generative model(s) 126 are utilized, those models may be included as part of the application services platform 110 or they may be external models that are called by the application services platform 110.

The request processing unit 122 also coordinates communication and exchange of data among components of the application services platform 110 as discussed in the examples which follow. The request processing unit 122 receives a user request to generate AI-generated graphic design images in the native application 114 or the browser application 112.

The prompt construction unit 124 may reformat or otherwise standardize any information to be included in the prompt to a standardized format that is recognized by the generative model(s) 126. The generative model(s) 126 is trained using training data in this standardized format, in some implementations, and utilizing this format for the prompts provided to the generative model(s) 126 may improve the output quality provided by the generative model(s) 126.

Some common formats recognized by a LMM include JPEG (Joint Photographic Experts Group), PNG (Portable Network Graphics, TIFF (Tagged Image File Format), BMP (Bitmap Image File), GIF (Graphics Interchange Format), PSD (Photoshop Document), RAW, SVG (Scalable Vector Graphics), WEBP, OpenEXR, or the like.

The system can instruct the generative model(s) 126 to generate a single-shot prompt (i.e., including a single example or instruction to guide the LMM's response) or a multi-shot prompt (i.e., including multiple examples or instructions to give the LMM more context and improve its understanding of the task) for generating AI-generated graphic design images.

In some implementations, when the user data from the user database 128 is already in the format directly processible by the generative model(s) 126, the prompt construction unit 124 does not need to convert the user data. In other implementations, when the user data is not in the format directly processible by the generative model(s) 126, the prompt construction unit 124 converts the user data to the format directly processible by the generative model(s) 126. Some common standardized formats recognized by a language model include plain text, HTML, JSON, XML, and the like. In one embodiment, the system converts user data into JSON, which is a lightweight and efficient data-interchange format.

The prompt construction unit 124 can convert the user data to a format directly processible by the LMM 126b, for example, for adjusting the new graphic design images rejected by the user. As such, the user data can be considered in adjusting the new graphic design images rejected by the user, such as bigger/smaller text size, higher/lower resolution, brighter/darker colors, higher/lower background similarity, and the like as discussed. Other implementations may include instructions in addition to and/or instead of one or more of these instructions.

In some implementations, the application services platform 110 includes moderation services that analyze user request(s)/prompt(s), graphic design images generated by the generative model(s) 126, and/or the user data obtained from the user database 128, to ensure that potentially objectionable or offensive content is not generated or utilized by the application services platform 110.

If potentially objectionable or offensive content is detected in the user data obtained from the user database 128, the moderation services provides a blocked content notification to the client device 105 indicating that the prompt(s), the user data is blocked from forming the meta prompt. In some implementations, the request processing unit 122 discards any user data that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative model(s) 126 as an input.

In one embodiment, the prompt construction unit 124 submits the prompt(s), and/or the meta prompt(s) to the moderation services to ensure that the prompt does not include any potentially objectionable or offensive content. The prompt construction unit 124 halts the processing of the user prompt(s), and/or the meta prompt(s) in response to the moderation services determining that the user prompt(s) and/or the visual content data includes potentially objectionable or offensive content.

The prompt construction unit 124 can halt the transformation of graphic design images in response to the moderation services determining that the graphic design includes potentially objectionable or offensive content. The moderation services generates a blocked content notification in response to determining that the AI-generated graphic design images include potentially objectionable or offensive content, and the notification is provided to the prompt construction unit 124. The prompt construction unit 124 may attempt to revise and resubmit the textual prompt. If the moderation services does not identify any issues with the transformed graphic design images, the prompt construction unit 124 provides the transformed graphic design images to the request processing unit 122. The request processing unit 122 provides the transformed graphic design images to the native application 114 or the browser application 112 depending upon which application was the source of the initial design content request. A technical benefit of this approach is that the moderation services provides safeguards against both user-created and model-created content to ensure that prohibited offensive or potentially offensive content is not presented to the user in the native application 114 or the browser application 112.

The user database 128 can be implemented on the application services platform 110 in some implementations. In other implementations, at least a portion of the user database 128 are implemented on an external server that is accessible by the prompt construction unit 124.

In some implementations, the application services platform 110 complies with privacy guidelines and regulations that apply to the usage of the user data included in the user database 128 to ensure that users have control over how the application services platform 110 utilizes their data. The user is provided with an opportunity to opt into the application services platform 110 to allow the application services platform 110 to access the user data and enable the generative model(s) 126 to generate transformed graphic design images. In some implementations, the first time that an application, such as the native application 114 or the browser application 112 presents an AI assistant to the user, the user is presented with a message that indicates that the user may opt into allowing the application services platform 110 to access user data included in the user database 128 to support the graphic design text editing functionality. The user may opt into allowing the application services platform 110 to access all or a subset of user data included in the user database 128. Furthermore, the user may modify their opt-in status at any time by accessing their user data and selectively opting into or opting out of allowing the application services platform 110 from accessing and utilizing user data from the user database 128 as a whole or individually.

In one embodiment, metadata can be generated for the new graphic design images to facilitate later retrieval based on a user query. For example, the metadata might detail that edited graphic design images are related to a company hackathon. Consequently, the same user's query related to a company hackathon poster can be matched to the stored graphic design images using the metadata.

The above-discussed visual content library 142 (storing e.g., initial/transformed graphic design images, or the like), request, prompts and responses 144, extracted/inferred user data 146 (e.g., user preferences), and other asset data 148 can be stored in the enterprise data storage 140. The extracted/inferred user data 146 (e.g., user preferences) can be collected via the above discussed user feedback loop, tentatively linked with a user ID during a user session and saved in a cache. After the user session, the extracted/inferred user data 146 is de-linked from the user ID as metadata of the transformed graphic design images and saved in the visual content library 142. In addition, the extracted/inferred user data 146 linked with the user ID is saved back to the user database 128.

The enterprise data storage 140 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

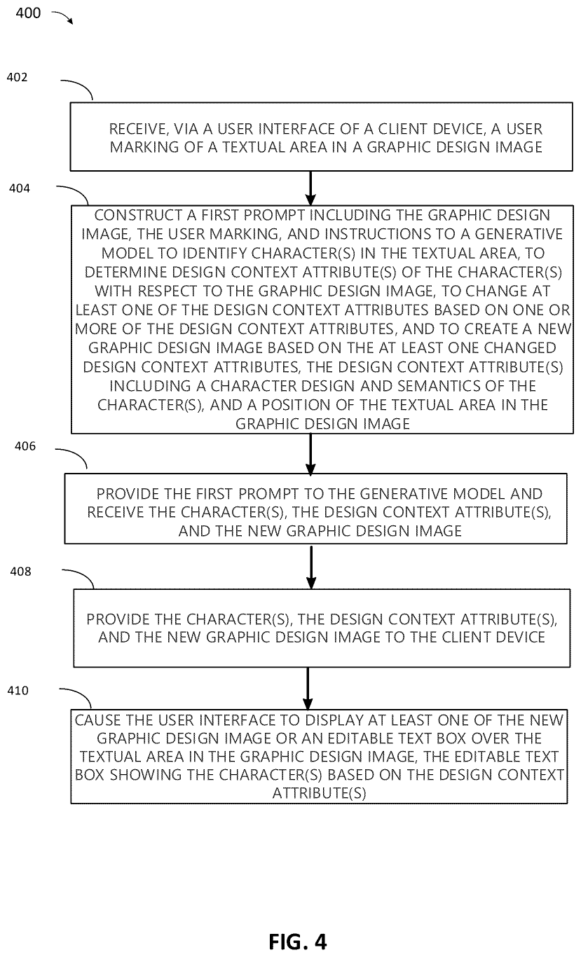

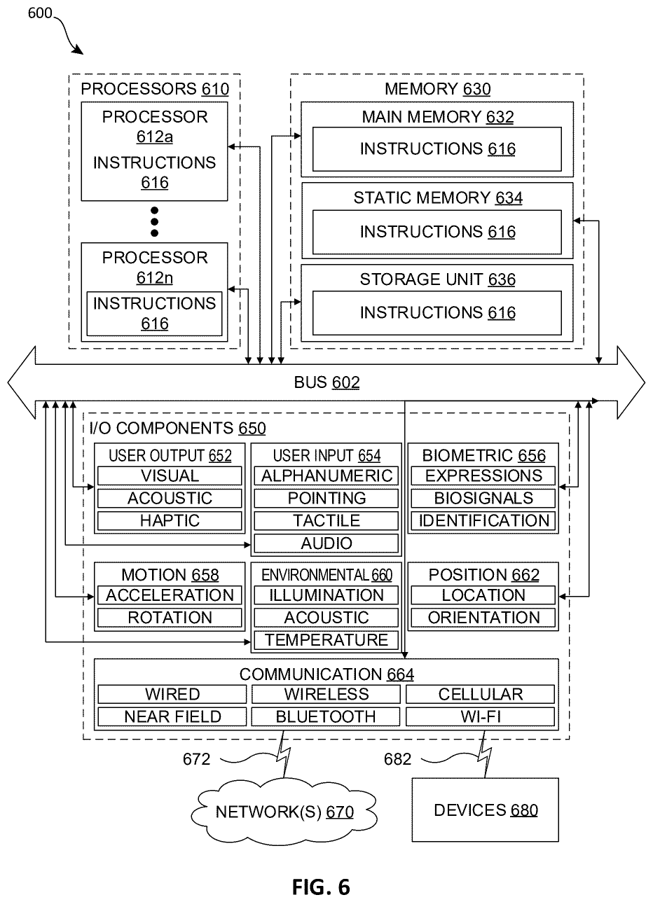

FIG. 4 is a flow chart of an example process for an AI graphic design text editing assistant according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, a request processing unit (e.g., the request processing unit 122) works in conjunction with the user gesture handler 132 to receive, via a user interface (e.g., the UI 160 in FIG. 1C, the UI 305 in FIGS. 3A-3C, or the like) of a client device (e.g., the client device 105), an indication of a user marking (e.g., the brush marking 164b in FIG. 1C) of a textual area (e.g., the textual area 164a in FIG. 1C) in a graphic design image (e.g., the graphic design image 164), the text area showing one or more characters (e.g., “Ask CEO Anything!”).

In step 404, a prompt construction unit (e.g., the prompt construction unit 124) works in conjunction with the contextual options provider 134 to construct a first prompt by appending the graphic design image and the user marking of the textual area in the graphic design image to a first instruction string, the first instruction string including instructions to a generative model (e.g., the LMM 126b, such as GPT-4V) to identify the one or more characters within the textual area, to determine one or more design context attributes of the one or more characters with respect to the graphic design image, to change at least one of the design context attributes (e.g., “save the day” in one character font in FIG. 3B) based on one or more of the design context attributes (e.g., company hackathon), and to create a new graphic design image (e.g., the image in FIG. 3C with “save the day” having a more vivid title font to match with the hackathon spirit) based on the at least one changed design context attributes, and the one or more design context attributes include a character design (e.g., a font, color, size, style, angle, or transparency level) and semantics (e.g., meanings taking into account the interplay of words, structure, and context) of the one or more characters, and a position of the textual area in the graphic design image (e.g., top center). For example, the generative model is a multimodal model. In step 406, the prompt construction unit provides as an input the first prompt to the generative model and receives as an output the one or more characters, the one or more design context attributes, and the new graphic design image (e.g., in FIG. 3C) from the generative model.

In one embodiment, the generative model is a multimodal model (e.g., the LMM 126b) that handle all of the instructions in the first instruction string. In another embodiment, the LLM 126a handles most of the instructions in the first instruction string except for generating the graphic design image that is left for the LVM 126c (e.g., Dalle-E, Sora, or the like) to handle.

In step 408, the request processing unit 122 works in conjunction with the user gesture handler 132 to provide the one or more characters, the one or more design context attributes, and the new graphic design image to the client device. In step 410, the request processing unit 122 works in conjunction with the user gesture handler 132 to cause the user interface of the client device to display at least one of the new graphic design image (e.g., in FIG. 3C) or an editable text box (e.g., the editable text box 166b in FIG. 1C) over the textual area in the graphic design image, wherein the editable text box shows the one or more characters based on the one or more design context attributes (e.g., “Ask the CEO Anything!” displayed “as is” over the box 166b in the image 166 shown in the UI 160 at the middle of FIG. 1C).

In one embodiment involving user added new characters (via an AI chat, via typing in the text box, or the like), the request processing unit 122 works in conjunction with the user gesture handler 132 to receive, via the editable text box, one or more new characters (e.g., typing “a salary raise” over “Anything”); and to cause the editable text box to display the one or more new characters (e.g., “a salary raise”) based on the one or more design context attributes (e.g., the font/size/color of “Ask CEO Anything!”). In another embodiment, the first instruction string further includes instructions to identify one or more new white spaces with a consistent color or style in the graphic design image. When determining that a length of the one or more new characters (e.g., “a salary raise”) exceeds a length of the editable text box, the request processing unit 122 works in conjunction with the user gesture handler 132 to cause the user interface of the client device to display an editable text box over the textual area and the one or more new white spaces (e.g., “Ask CEO a salary raise!”) in the graphic design image, and the editable text box shows the one or more new characters.

In some implementations involving changing at least one of the design context attributes, the design context attributes further include at least one of a visual hierarchy of the one or more characters in the graphic design image, a balance of the one or more characters with respect to white space in the graphic design image, a theme of the graphic design image, a formality of the graphic design image, or a color scheme of the graphic design image. Thus, the request processing unit 122 works in conjunction with the user gesture handler 132 to provide the new graphic design image to the client device; and to cause the user interface of the client device to display the editable text box over the textual area in the new graphic design image.

In an example, the first instruction string further includes instructions to change the character design of the one or more characters (e.g., “A brown bag lunch & learn UI design”) based on the semantics of the one or more characters (e.g., “brown bag lunch”) in the new graphic design image, and the character design includes at least one of a font, color, size, style, angle, or transparency level. As another example, the first instruction string further includes instructions to change the position of the textual area (e.g., to the top) in the graphic design image based on the semantics of the one or more characters (e.g., “Join us to see the solar eclipse!”) in the new graphic design image.

In another embodiment involving image background, the first instruction string further includes instructions to identify a background style (e.g., a desert) of the graphic design image, and to change the character design of the one or more characters (e.g., “Camping in a desert!”) to match with the background style, and the editable text box shows the one or more characters in the changed character design that matches the background style. As another example, the first instruction string further includes instructions to identify a background of the graphic design image, and to change the background of the graphic design image to a higher contrast to the character design, and the user interface of the client device displays the at least one of the new graphic design image or the editable text box over the textual area in the changed background.

In one embodiment involving translation, the first instruction string further includes instructions to determine a language of the one or more characters (e.g., English), and to translate the one or more characters into another language (e.g., Germany) based on a user preference, and the user interface of the client device displays the at least one of the new graphic design image or the editable text box showing the translated one or more characters.

In one embodiment involving auto-rewriting (e.g., summary, elaboration, conversion, or the like), the first instruction string further includes instructions to re-write the one or more characters (e.g., a poem) based on a user preference, and the user interface of the client device displays the at least one of the new graphic design image or the editable text box showing the rewritten one or more characters (e.g., haiku, a Japanese poetic form).

In one embodiment involving user edits, the request processing unit 122 works in conjunction with the user gesture handler 132 to cause the user interface of the client device to display an instruction for a user to edit the one or more characters displayed in the editable text box. Upon receiving a character edited or added in the editable text (e.g., typing “a” over “A” in “Anything”), the request processing unit 122 works in conjunction with the user gesture handler 132 to retrieve a corresponding character (e.g., “a”) in the character design and to display the corresponding character in the character design in the editable text in real-time or substantially real-time.

In some implementations involving non-standard character designs (e.g., the stylish yet misspelled “Gren” 154a in the AI-generated graphic design image 154 in FIG. 1B), the first instruction string further includes instructions to determine the character design is non-standard, to identify a standard character design closest to the non-standard character design, and to change the character design of the one or more characters into the standard character design, and the user interface of the client device displays the at least one of the new graphic design image or the editable text box showing the rendered one or more characters in the standard character design.

As another example, the first instruction string further includes instructions to determine the character design is non-standard, and to create an image of the one or more characters in the non-standard character design, and the user interface of the client device displays the editable text box showing the image of the one or more characters in the non-standard character design. In this example, as receiving a character edited or added in the editable text, the prompt construction unit constructs a second prompt by appending the character edited or added in the editable text to a second instruction string, the second instruction string including instructions to the generative model to create an image of the character edited or added in the non-standard character design. The prompt construction unit provides as an input the first prompt to the generative model and receiving as an output the image of the character edited or added in the non-standard character design from the generative model. Thus the request processing unit 122 works in conjunction with the user gesture handler 132 to provide the image of the character edited or added in the non-standard character design to the client device; and causes the user interface of the client device to display the image of the character edited or added in the non-standard character design in the editable text box over the textual area in the graphic design image in real-time or substantially real-time as receiving the character.

In one embodiment, the request processing unit 122 stores user content consumption need and/or preference in a user profile, when the user signs up for a platform (e.g., a web-based collaborative platform, a social media platform, a gaming platform, or the like) or application (e.g., Microsoft Copilot®, a team collaboration application, or the like), or when the user activates the platform or application. The request processing unit 122 then applies the user profile to at least one function (e.g., emails, chat and video conferencing, file-sharing, or the like) of the platform or application in addition to the AI graphic design text editing.

The system allows users to edit text in AI-generated graphic design images thus simplifying the creative process for the users. This ease of use increases user productivity and utilization, and attracts more non-technical users. By offering the graphic design text editing, the system eliminates the need for a user to manually opening an image editing program to in-paint the background then add new text. This solution makes AI-generated graphic design text editing process more efficient and open. The system can apply the AI-generated graphic design text editing to a range of data types, including images, images with text, videos, animations, or the like, thereby enhancing the accessibility of a design content creation platform/application for users with different content design preferences.

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In one embodiment, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative model(s) 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative model(s) 126 itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data (especially user data) is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

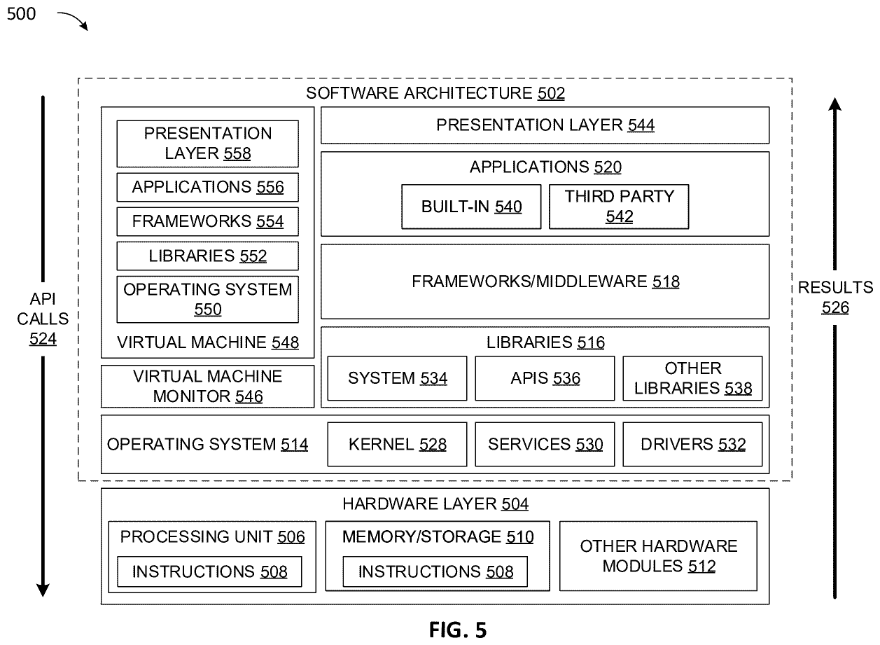

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform the following operations:
receiving, via a user interface of a client device, an indication of a user marking of a textual area in a graphic design image, the textual area showing one or more characters;
constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image;
providing as an input the first prompt to the generative model and receiving as an output the one or more characters, the one or more design context attributes, and the new graphic design image from the generative model;
providing the one or more characters, the one or more design context attributes, and the new graphic design image to the client device; and
causing the user interface of the client device to display at least one of the new graphic design image or an editable text box over the textual area in the graphic design image, wherein the editable text box shows the one or more characters based on the one or more design context attributes.

2. The data processing system of claim 1, wherein the machine-readable storage medium further includes instructions configured to cause the processor alone or in combination with other processors to perform operations of:
receiving, via the editable text box, one or more new characters; and
causing the editable text box to display the one or more new characters based on the one or more design context attributes.

3. The data processing system of claim 2, wherein the first instruction string further includes instructions to identify one or more new white spaces with a consistent color or style in the graphic design image, and the machine-readable storage medium further includes instructions configured to cause the processor alone or in combination with other processors to perform operations of:
when determining that a length of the one or more new characters exceeds a length of the editable text box, causing the user interface of the client device to display an editable text box over the textual area and the one or more new white spaces in the graphic design image, wherein the editable text box shows the one or more new characters.

4. The data processing system of claim 1, wherein the machine-readable storage medium further includes instructions configured to cause the processor alone or in combination with other processors to perform operations of:
causing the user interface of the client device to display the editable text box over the textual area in the new graphic design image.

5. The data processing system of claim 1, wherein the design context attributes further include at least one of a visual hierarchy of the one or more characters in the graphic design image, a balance of the one or more characters with respect to white space in the graphic design image, a theme of the graphic design image, a formality of the graphic design image, or a color scheme of the graphic design image.

6. The data processing system of claim 1, wherein the first instruction string further includes instructions to change the character design of the one or more characters based on the semantics of the one or more characters in the new graphic design image, and wherein the character design includes at least one of a font, color, size, style, angle, or transparency level.

7. The data processing system of claim 1, wherein the first instruction string further includes instructions to change the position of the textual area in the graphic design image based on the semantics of the one or more characters in the new graphic design image.

8. The data processing system of claim 1, wherein the first instruction string further includes instructions to identify a background style of the graphic design image, and to change the character design of the one or more characters to match with the background style, and
wherein the editable text box shows the one or more characters in the changed character design that matches the background style.

9. The data processing system of claim 1, wherein the first instruction string further includes instructions to identify a background of the graphic design image, and to change the background of the graphic design image to a higher contrast to the character design, and
wherein the user interface of the client device displays the at least one of the new graphic design image or the editable text box over the textual area in the changed background.

10. The data processing system of claim 1, wherein the first instruction string further includes instructions to determine a language of the one or more characters, and to translate the one or more characters into another language based on a user preference, and
wherein the user interface of the client device displays the at least one of the new graphic design image or the editable text box showing the translated one or more characters.

11. The data processing system of claim 1, wherein the first instruction string further includes instructions to re-write the one or more characters based on a user preference, and
wherein the user interface of the client device displays the at least one of the new graphic design image or the editable text box showing the rewritten one or more characters.

12. The data processing system of claim 1, wherein the machine-readable storage medium further includes instructions configured to cause the processor alone or in combination with other processors to perform operations of:
causing the user interface of the client device to display an instruction for a user to edit the one or more characters displayed in the editable text box.

13. The data processing system of claim 12, wherein the machine-readable storage medium further includes instructions configured to cause the processor alone or in combination with other processors to perform operations of:
upon receiving a character edited or added in the editable text, retrieving a corresponding character in the character design and displaying the corresponding character in the character design in the editable text in real-time or substantially real-time.

14. The data processing system of claim 1, wherein the generative model is a multimodal model.

15. A method comprising:
receiving, via a user interface of a client device, an indication of a user marking of a textual area in a graphic design image, the textual area showing one or more characters;
constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image;
providing as an input the first prompt to the generative model and receiving as an output the one or more characters, the one or more design context attributes, and the new graphic design image from the generative model;
providing the one or more characters, the one or more design context attributes, and the new graphic design image to the client device; and
causing the user interface of the client device to display at least one of the new graphic design image or an editable text box over the textual area in the graphic design image, wherein the editable text box shows the one or more characters based on the one or more design context attributes.

16. The method of claim 15, wherein the first instruction string further includes instructions to generate one or more new characters based on the one or more design context attributes, and the method further comprising:
receiving, via the editable text box, one or more new characters; and
causing the editable text box to display the one or more new characters based on the one or more design context attributes.

17. The method of claim 16, wherein the first instruction string further includes instructions to identify one or more new white spaces with a consistent color or style in the graphic design image, and the method further comprising:
when determining that a length of the one or more new characters exceeds a length of the editable text box, causing the user interface of the client device to display an editable text box over the textual area and the one or more new white spaces in the graphic design image, wherein the editable text box shows the one or more new characters.

18. A non-transitory computer readable medium on which are stored instructions that, when executed, cause a programmable device to perform functions of:
receiving, via a user interface of a client device, an indication of a user marking of a textual area in a graphic design image, the textual area showing one or more characters;
constructing, via a prompt construction unit, a first prompt by appending the graphic design image and the user marking of the textual area in the graphic design image to a first instruction string, the first instruction string including instructions to a generative model to identify the one or more characters within the textual area, to determine one or more design context attributes of the one or more characters with respect to the graphic design image, to change at least one of the design context attributes based on one or more of the design context attributes, and to create a new graphic design image based on the at least one changed design context attributes, wherein the one or more design context attributes include a character design and semantics of the one or more characters, and a position of the textual area in the graphic design image;
providing as an input the first prompt to the generative model and receiving as an output the one or more characters, the one or more design context attributes, and the new graphic design image from the generative model;
providing the one or more characters, the one or more design context attributes, and the new graphic design image to the client device; and
causing the user interface of the client device to display at least one of the new graphic design image or an editable text box over the textual area in the graphic design image, wherein the editable text box shows the one or more characters based on the one or more design context attributes.

19. The non-transitory computer readable medium of claim 18, wherein the first instruction string further includes instructions to generate one or more new characters based on the one or more design context attributes, and the instructions when executed, further cause the programmable device to perform functions of:
receiving, via the editable text box, one or more new characters; and
causing the editable text box to display the one or more new characters based on the one or more design context attributes.

20. The non-transitory computer readable medium of claim 19, wherein the first instruction string further includes instructions to identify one or more new white spaces with a consistent color or style in the graphic design image, and the instructions when executed, further cause the programmable device to perform functions of:
when determining that a length of the one or more new characters exceeds a length of the editable text box, causing the user interface of the client device to display an editable text box over the textual area and the one or more new white spaces in the graphic design image, wherein the editable text box shows the one or more new characters.
